(19) United States
(12) Patent Application Publication
(10) Pub. No.: US 2014/0298343 A1
(43) Pub. Date: Oct. 2, 2014

(54) METHOD AND SYSTEM FOR SCHEDULING ALLOCATION OF TASKS

(71) Applicant: XEROX CORPORATION, Norwalk, CT (US)

(72) Inventors: Vaibhav Rajan, Kammanahalli, Bangalore (IN); Koustuv Dasgupta, Hebbal, Bangalore (IN); Laura E. Celis, Karnataka, Bangalore (IN)

(73) Assignee: XEROX CORPORATION, Norwalk, CT (US)

(21) Appl. No.: 13/850,427

(22) Filed: Mar. 26, 2013

(51) Int. Cl. G06F 9/48

(52) U.S. Cl. CPC G06F 9/4881
USPC 718/102

(57) ABSTRACT

A method and system for scheduling allocation of a plurality of tasks to a service platform is disclosed. The method includes allocating a current batch of tasks from the plurality of tasks to the service platform based on an optimization model. The method further includes updating the optimization model after at least one of an expiry of a predefined time interval or receiving the responses for the current batch of tasks.

### TECHNICAL FIELD

The presently disclosed embodiments are related to management of tasks. More particularly, the presently disclosed embodiments are related to a method and system for scheduling allocation of a plurality of tasks to a service platform.

### BACKGROUND

The scheduling of tasks on a service platform using a scheduling system involves a complex task of identifying platform characteristics, resource characteristics, task characteristics, performance characteristics, and the like. These characteristics vary with time, hence it is difficult to monitor and control the performance indicators so as to meet task requirements while scheduling the tasks. If the scheduling is done in a suboptimal manner then it requires enterprises to invest more time and expense on the scheduling system to meet task requirements. In addition, this may lead to the enterprises being unable to meet the service level agreements (SLAs).

Various solutions for scheduling assume complete control and/or knowledge of the service platform. Some other solutions address the problem by allocating the tasks to the service platform by varying resources in the scheduling system. However, these solutions do not address the problem of scheduling tasks in the presence of rapidly changing characteristics of the service platform.

### SUMMARY

According to embodiments illustrated herein, there is provided a computer-implemented method for scheduling allocation of a plurality of tasks to a service platform. The computer-implemented method includes allocating a current batch of tasks from the plurality of tasks to the service platform based on an optimization model, wherein the optimization model alters values of one or more control parameters for the current batch of tasks based on values of one or more response parameters derived from responses received for a previous batch of tasks, and wherein the optimization model is built by machine learning on the responses received from the service platform. The method further includes updating the optimization model after at least one of an expiry of a predefined time interval or receiving the responses for the current batch of tasks.

According to embodiments illustrated herein, there is provided a system for scheduling allocation of a plurality of tasks to a crowdsourcing platform. The system includes a scheduling module configured for allocating a current batch of tasks from the plurality of tasks to the crowdsourcing platform based on an optimization model, wherein the optimization model alters values of one or more control parameters for the current batch of based on values of one or more response parameters derived from responses received for a previous batch of tasks, and wherein the optimization model is built by machine learning on the responses received from the crowdsourcing platform. The system further includes a maintenance module configured for updating the optimization model after at least one of an expiry of a predefined time interval or receiving the responses for the current batch of tasks.

According to embodiments illustrated herein, there is provided a computer program product for use with a computer. The computer program product computer-usable data carrier storing a computer-readable program code embodied therein for scheduling allocation of a plurality of tasks to a service platform. The computer program product includes a program instruction means for allocating a current batch of tasks from the plurality of tasks to the service platform based on an optimization model, wherein the optimization model alters values of one or more control parameters for the current batch of tasks based on values of one or more response parameters derived from responses received for a previous batch of tasks, and wherein the optimization model is built by machine learning on the responses received from the service platform. The computer program product further includes a program instruction means for updating the optimization model after at least one of an expiry of a predefined time interval or receiving the responses for the current batch of tasks.

### BRIEF DESCRIPTION OF DRAWINGS

The accompanying drawings illustrate various embodiments of systems, methods, and various other aspects of the invention. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment, in accordance with at least one embodiment;

FIG. 2 is a block diagram illustrating a system for scheduling allocation of tasks, in accordance with at least one embodiment; and

FIG. 3 is a flow diagram illustrating a method for scheduling allocation of tasks, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, the repeated use of the phrase “in an embodiment” does not necessarily refer to the same embodiment.

### DEFINITIONS

The following terms shall have, for the purposes of this application, the respective meanings set forth below.

A “network” refers to a medium that interconnects various computing devices, service platform servers, crowdsourcing platform servers, and an application server. Examples of the network include, but are not limited to, LAN, WLAN, MAN, WAN, the Internet, and the like. Communication over the network may be performed in accordance with various communication protocols such as Transmission Control Protocol and Internet Protocol (TCP/IP), User Datagram Protocol (UDP), and IEEE 802.11n communication protocols.

A “computing device” refers to a computer, a device including a processor/microcontroller and/or any other electronic component, or a device or a system that performs one or more operations according to one or more programming instructions. Examples of the computing device include, but are not limited to, a desktop computer, a laptop, a personal digital assistant (PDA), a tablet computer and the like. The computing device is capable of communicating with the service platform server, the crowdsourcing platform server, and the application server by means of the network (e.g., using wired or wireless communication capabilities).

“Crowdsourcing” refers to distributing tasks by soliciting the participation of defined groups of users. A group of users may include, for example, individuals responding to a solicitation posted on a certain website (e.g., crowdsourcing platform), such as Amazon Mechanical Turk, Crowd Flower, and the like.

“A service platform” refers to a business application which handles the execution of a batch of tasks/jobs on distributed resource management systems. Various examples of the service platforms include, but are not limited to, IT service platform, a crowdsourcing platform, and the like. In an embodiment, the IT service platform or the crowdsourcing platform can be installed on a network operating system (e.g., UNIX and Windows systems) or hosted on a web portal. The crowdsourcing platform refers to a business application, wherein a broad, loosely defined external group of people, community, or organization provides solutions as outputs for any specific business processes received by the application as input. Various examples of the crowdsourcing platforms include, but are not limited to, Amazon Mechanical Turk or Crowd Flower. The IT service platform refers to a business application for executing one or more IT services or network services. Various examples of the IT service platforms include, but are not limited to, IBM Platform LSF, Oracle Grid Engine, IBM Loadleveler, and the like.

“Crowdworkers” refer to a worker or a group of workers that may perform one or more tasks that generate data that contribute to a defined result, such as proofreading part of a digital version of an ancient text or analyzing a small quantum of a large volume of data. According to the present disclosure, the crowdworkers include, but are not limited to, a satellite centre employee, a rural BPO (Business Process Outsourcing) firm employee, a home-based employee, or an internet-based employee. Hereinafter, “crowdsourced workforce,” “crowdworker,” “crowd workforce,” and “crowd” may be interchangeably used.

“Task” refers to a piece of work, an activity, an action, a job, an instruction or an assignment to be performed. In an embodiment, the task can be undertaken by the crowdworker. The task can be accessed by remote users/crowdworkers from the service platform. Examples of the task may include, but is not limited to digitization, video annotation, image labeling, and the like.

“Parameters” refer to measurable characteristics of plurality of tasks. Examples of the parameters may include, but are not limited to, task performance parameters (e.g., accuracy, response time, etc), spatio temporal parameters (e.g., cost, number of judgments, etc.), task characteristics parameters (e.g., cost, number of judgments, task category, etc.), fault tolerance measures, resource utilization, and the like.

“Values” refer to the measurement of the parameters associated with the plurality of tasks. Examples of the values may include, but are not limited to, nominal, text, percentages, and the like.

“Response parameters” (R) or “Externally observable characteristics” (EOC) refer to the parameters of the plurality of tasks that are determined from the responses received from the service platform. In an embodiment, the response parameters may include, but are not limited to, accuracy, response time, cost, and the like. The values of the response parameters or the externally observable characteristics depend, directly or indirectly, on the nature of work associated with the one or more tasks, the time of posting the plurality of tasks, and the like. Hereinafter, the terms response parameters or the EOC may be interchangeably used.

“Control parameters” (C) refer to parameters of the plurality of tasks whose values may be varied to optimize the values of the response parameters. In an embodiment, the control parameters may include, but are not limited to, batch size, cost of each task, number of judgments, and the like.

“Requester's preferences” refer to details of the plurality of tasks which are specified by the requester. In an embodiment, the requester's preferences contain values of the one or more control parameters and the one or more response parameters associated with the plurality of tasks.

“Batch completion time” refers to a time when a batch of tasks from the plurality of tasks is to be completed based on the requester's specifications.

A “predefined interval” refers to a time interval during which the batch of tasks is assigned to the service and is waiting to be completed. In an embodiment, the predefined interval is determined based on the values of a batch completion time provided in the requester's preferences.

“Batch completion rate” refers to a percentage of the batch of tasks to be completed within the batch completion time.

“Number of judgments” refers to a count of independent crowdworkers who are to be assigned the plurality of tasks.

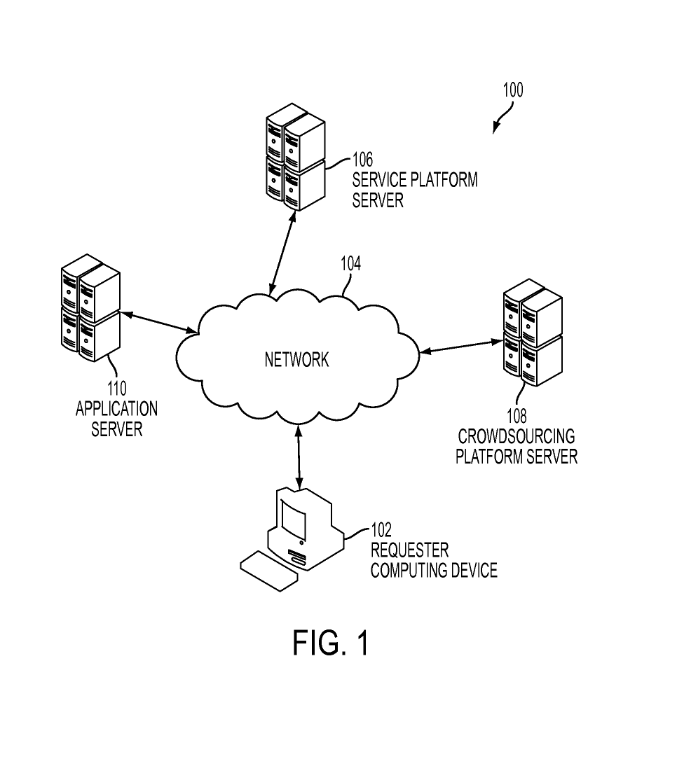

FIG. 1 is a block diagram illustrating a system environment 100, in accordance with at least one embodiment. Various embodiments of the methods and systems for scheduling allocation of a plurality of tasks to a service platform (e.g., IT service platform or crowdsourcing platform) are implementable in the system environment 100. The system environment 100 includes a requester computing device 102, a network 104, a service platform server 106, crowdsourcing platform server 108, and an application server 110. A user of the requester computing devices 102 is hereinafter referred to as a requester (e.g., who posts the tasks on the crowdsourcing platform).

Although FIG. 1 shows only one type (e.g., a desktop computer) of the requester computing device 102 for simplicity, it will be apparent to a person having ordinary skill in the art that the disclosed embodiments can be implemented for a variety of computing devices including, but not limited to, a desktop computer, a laptop, a personal digital assistant (PDA), a tablet computer, and the like.

The service platform server 106 is a device or a computer that hosts a service platform and is interconnected to the requester computing device 102 over the network 104. The service platform (e.g., the IT service platform) accepts the plurality of tasks from the requester computing device 102 and sends back responses for the executed plurality of tasks on the service platform to the requester computing device 102. Examples of the plurality of tasks include, but are not limited to, concurrent transactions, accessing files from a distributed system, detecting fault tolerance, and the like.

The crowdsourcing platform server 108 is a device or a computer that hosts a crowdsourcing platform and is interconnected to the requester computing device 102 over the network 104. The crowdsourcing platform accepts the plurality of tasks to be crowdsourced and sends back responses for the crowdsourced tasks. Examples of the crowdsourced tasks include, but are not limited to, digitization of forms, translation of a literary work, multimedia annotation, content creation, and the like. In an embodiment, for example, an enterprise managing the crowdsourcing platform is an enterprise partner of the requester.

In an embodiment, an application/tool/framework for scheduling the allocation of the plurality of tasks may be hosted on the application server 110. In another embodiment, the application/tool/framework for scheduling the allocation of the plurality of tasks may be installed as a client application on the requester computing device 102.

The application receives the requester's preferences/specifications over the network 104, and schedules the allocation of the plurality of tasks by sending batches of tasks from the plurality of tasks to the service platform server 106 or the crowdsourcing platform server 108 over the network 104. The application receives responses from the service platform server 106 or the crowdsourcing platform server 108 for the batches of tasks over the network 104 which are then forwarded to the requester over the network 104.

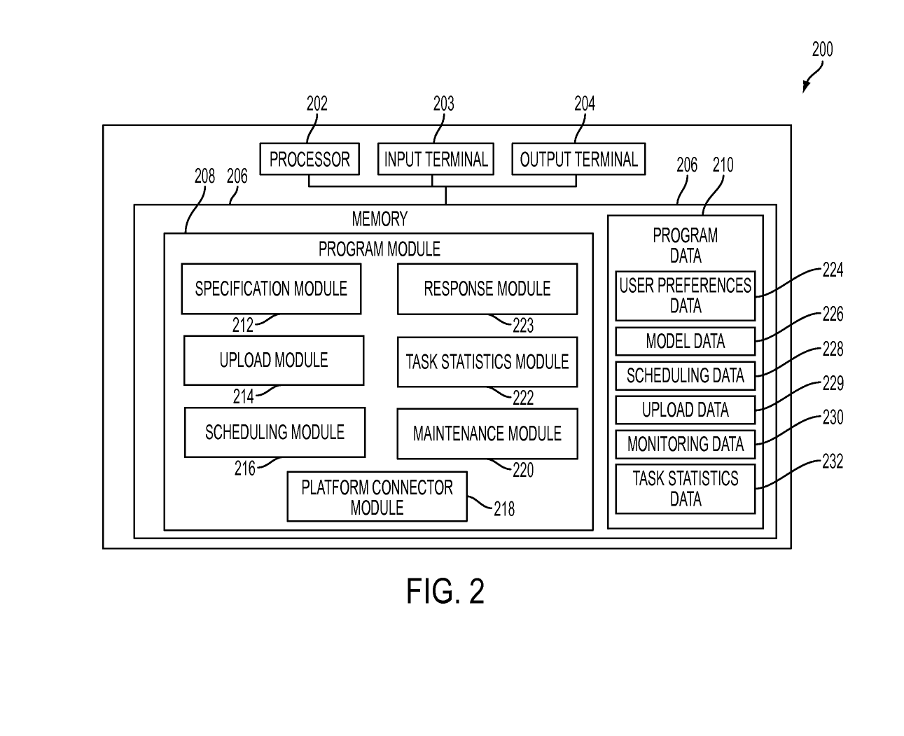

FIG. 2 is a block diagram illustrating a system 200, in accordance with at least one embodiment. The system 200 (hereinafter alternatively referred to as CrowdControl 200) may correspond to either the application server 110 (in case when the application for scheduling the allocation of tasks is hosted on the application server 110) or the requester computing device 102 (in case when the application for scheduling the allocation of tasks is executed on the requester computing device 102).

The system 200 includes a processor 202, an input terminal 203, an output terminal 204, and a memory 206. The memory 206 includes a program module 208 and a program data 210. The program module 208 includes a specification module 212, an upload module 214, a scheduling module 216, a maintenance module 220, a platform connector module 218, a task statistics module 222, and a response module 223. The program data 210 includes a user preferences data 224, a model data 226, a scheduling data 228, an upload data 229, a monitoring data 230, and a task statistics data 232. In an embodiment, the memory 206 and the processor 202 may be coupled to the input terminal 203 and the output terminal 204 for one or more inputs and display, respectively.

The processor 202 executes a set of instructions stored in the memory 206 to perform one or more operations. The processor 202 can be realized through a number of processor technologies known in the art. Examples of the processor 202 include, but are not limited to, an X86 processor, a RISC processor, an ASIC processor, a CISC processor, or any other processor. In an embodiment, the processor 202 includes a Graphics Processing Unit (GPU) that executes the set of instructions to perform one or more image processing operations.

The input terminal 203 receives the requester's preferences and a request for uploading the plurality of tasks from the requester. Examples of the input terminals include, but are not limited to, keyboard, mouse, joystick, voice recognition device, touch screen, fingerprint reader, light pen, and the like. The output terminal 204 displays the results of the plurality of tasks executed on the service platform. Examples of the output terminals that is capable to provide video output may include, but are not limited to, CRT monitors, LCD monitors, LED monitors, plasma monitors, television screen, and the like.

The memory 206 stores a set of instructions and data. Some of the commonly known memory implementations can be, but are not limited to, a Random Access Memory (RAM), Read Only Memory (ROM), Hard Disk Drive (HDD), and a secure digital (SD) card. The program module 208 includes a set of instructions that are executable by the processor 202 to perform specific actions such as scheduling the allocation of the plurality of tasks. It is understood by a person having ordinary skill in the art that the set of instructions in conjunction with various hardware of the CrowdControl 200 enable the CrowdControl 200 to perform various operations. During the execution of instructions, the user preferences data 224, the model data 226, the scheduling data 228, the upload data 229, the monitoring data 230, and the task statistics data 232 may be accessed by the processor 202.

The specification module 212 receives the requester's preferences containing the details of the plurality of tasks to be crowdsourced. In an embodiment, the requester's preferences contain the details of one or more control parameters and one or more response parameters of the plurality of tasks. In an embodiment, for example, the one or more response parameters are accuracy, response time, cost, and the like. In an embodiment, for example, the one or more control parameters are cost, number of judgments, batch size, and the like. The specification module 212 stores the received values of the one or more control parameters and the one or more response parameters in the user preferences data 224.

The upload module 214 receives a request from the requester containing the plurality of tasks to be crowdsourced. In an embodiment, the upload module 214 stores the plurality of tasks with its associated requester's preferences in the upload data 229.

The scheduling module 216 retrieves the scheduling data 228 and the upload data 229, and allocates a current batch of tasks from the plurality of tasks to a selected service platform based on an optimization model contained in the scheduling data 228. The optimization model is discussed under the operation of the task statistics module 222. In an embodiment, the plurality of tasks is divided into batches of tasks based on the values of the batch size contained in the requester's preferences. In an embodiment, the scheduling module 216 uploads the batches of tasks to the selected service platform based on the optimization model in the scheduling data 228 at predefined time intervals till the plurality of tasks are completely executed. In an embodiment, for example, let the response parameters R correspond to accuracy, response time of a task, and cost. Let the control parameters C correspond to the batch size and cost. Let N be the input batch size, Y the minimum accuracy, T the batch completion time, and C the budget. The scheduling module 216 attempts to complete all N tasks using the optimization model such that all tasks in the batch have at least accuracy Y and the entire batch of tasks is completed within time T and cost C. However, it tries to achieve the maximum accuracy possible (above Y), and the minimum cost and completion time possible (below C and T, respectively). In order to do so, it schedules the tasks in smaller batches (bᵢ) of tasks. In each batch bᵢ, the scheduling module 216 may vary the batch size and the cost of the tasks such that the total cost (over all batches) does not exceed C.

The platform connector module 218 receives responses corresponding to the current batch of tasks from the selected service platform and stores information contained in the responses in the task statistics data 232.

The maintenance module 220 determines the values of one or more EOCs from the task statistics data 232 of the selected service platform and updates the optimization model in the scheduling data 228. In an embodiment, the maintenance module 220 updates the optimization model after an expiry of the predefined time interval or receiving the responses for the current batch of tasks in the task statistics data 232. In an embodiment, the maintenance module 220 stores the determined values of the one or more EOCs provided in the request to the upload module 214 in the monitoring data 230. The monitoring data 230 contains optimized (e.g., advantageous/beneficial result/values in a given practical situation, and should not be construed to mean a mathematically-provable optimum/maximum) values of the response parameters generated using the optimization model. In an embodiment, the maintenance module 220 updates the statistical model maintained for the selected service platform in the model data 226 based on the optimization model generated after the execution of the plurality of tasks.

The task statistics module 222 retrieves the one or more statistical models maintained for the plurality of service platforms in the model data 226 a request. In an embodiment, the request is received from the requester and contains a choice of a service platform to be selected from the plurality of service platforms. In an embodiment, the method for creating, updating the one or more statistical models, and recommending one or more crowdsourcing platforms is disclosed in the U.S. patent application entitled, “METHOD AND SYSTEM FOR RECOMMENDING CROWDSOURCING PLATFORMS”, application Ser. No. 13/794,861 filed on Mar. 12, 2013 (Attorney File 20121075), and assigned to the same assignee, and which is herein incorporated by reference in its entirety.

The task statistics module 222 then creates an initial optimization model for the selected service platform from the model data 226 based on the request and stores the optimization model in the scheduling data 228. In an embodiment, for a first batch of tasks from the plurality of tasks, the task statistics module 222 creates the initial optimization model from the statistical models maintained for the selected service platform based on the request, and the initial optimization model is stored in the scheduling data 228.

The response module 223 retrieves the monitoring data 230 and facilitates the display of the results in the monitoring data 230 containing theoretical guarantees to the requester on the output terminal 204 after the complete execution of the plurality of tasks.

The optimization model described in the CrowdControl 200 corresponds to a model whose aim is to find a balance between the expectations stated in the requester's preferences and the values achieved in the responses received from the service platform. The optimized values generated using the optimization model shall be construed broadly to mean any advantageous result in a given practical situation, and should not be construed to mean a mathematically-provable optimum/maximum.

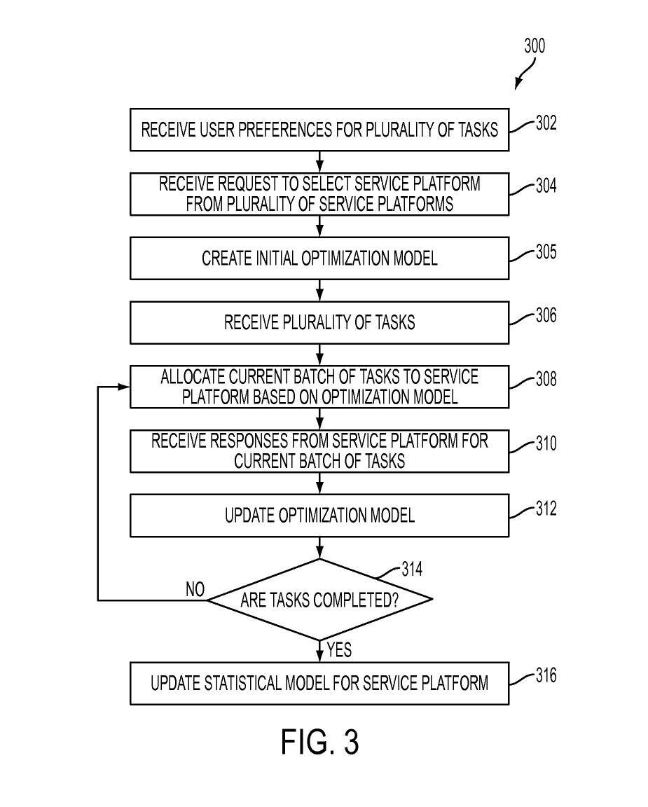

FIG. 3 is a flow diagram 300 illustrating a method for scheduling allocation of the plurality of tasks to the service platform, in accordance with at least one embodiment. The plurality of tasks is allocated to the service platform based on the scheduling data 228. The CrowdControl 200 uses the following method:

At step 302, the requester's preferences for the plurality of tasks are received. In an embodiment, the specification module 212 receives the requester's preferences for the plurality of tasks from the requester and the information is stored in the user preferences data 224. In an embodiment, the requester's preferences for the crowdsourcing platform may include values corresponding to, but not limited to, task performance parameters, spatio temporal parameters, and task characteristics parameters. For example, the task characteristics parameters may include, but are not limited to, batch size of 50 and desired task accuracy of 50 percent. The task performance parameters may include, but is not limited to, cost of $1. The spatio temporal parameters may include, but is not limited to, number of judgments as 5. In an embodiment, the requester's preferences may also contain a range (tolerance value) for the values in the batch specifications. In an embodiment, the requester's preferences for the IT service platform may include values corresponding to, but not limited to, fault tolerance measures, resource utilization, accuracy, completion time, and the like.

At step 304, a request is received for selecting a service platform from the plurality of service platforms. In an embodiment, the request is received from the requester, which contains a choice of the service platform from the plurality of service platforms.

At step 305, an initial optimization model is created. The task statistics module 222 creates the initial optimization model from the statistical model maintained for the selected service platform in the model data 226 based on the request, and the initial optimization model is stored in the scheduling data 228. The initial optimization model corresponds to the statistical model created for the selected service platform disclosed in the U.S. patent application entitled, “METHOD AND SYSTEM FOR RECOMMENDING CROWDSOURCING PLATFORMS”, application Ser. No. 13/794,861, filed on Mar. 12, 2013 (Attorney File 20121075), and assigned to the same assignee.

At step 306, the plurality of tasks is received. In an embodiment, the upload module 214 receives a request from the requester containing the plurality of tasks to be crowdsourced. In an embodiment, the upload module 214 stores the plurality of tasks in the upload data 229.

At step 308, a current batch of tasks is allocated to the service platform based on the optimization model. In an embodiment, the scheduling module 216 retrieves the scheduling data 228 and the upload data 229, and allocates the current batch of tasks from the plurality of tasks to the service platform based on the optimization model contained in the scheduling data 228. In an embodiment, the plurality of tasks is divided into batches of tasks based on the values of the batch size contained in the requester's preferences. In an embodiment, the scheduling module 216 allocates the batches of tasks to the selected service platform at the predefined time intervals till the plurality of tasks are completely executed.

The scheduling module 216 schedules the execution of the batches of tasks in rounds using a stochastic solution. In an embodiment, a Bayesian Optimization method is used for providing the stochastic solution. The Bayesian Optimization method solves the task optimization problem by optimization and learning. The Bayesian Optimization method sequentially optimizes an unknown function ƒ(xₜ) in each round t by varying xₜ, such that

xₜεD.

The value of the function ƒ is observed for noise using

yₜ=ƒ(xₜ)ò,

where
D represents a domain (e.g., crowdsourcing, IT service platform, etc.),
xₜ represents the one or more control parameters of the domain D,
yₜ represents the one or more response parameters, and
òₜ˜N(0,σ²) is the Gaussian noise.
   The Bayesian Optimization method tries to maximize the sum of the values of the function ƒ without noise Σ₁^{T}ƒ(xₜ), in T rounds. The Bayesian Optimization method attempts to sample the best possible xₜ from the domain D at each round t with the aim of maximizing the sum for Σ₁^{T}ƒ(xₜ) by evaluating a common performance metric such as cumulative regret. The regret in each round t is the loss due to not knowing the function Σ₁^{T}ƒ(xₜ) in advance and is represented as rₜ=ƒ(x*) ƒ(xₜ)− and the cumulative regret is represented as R_{T}=Σ₁^{T}rₜ.

In this case, the scheduling module 216 models the response parameters (R) as a function of the control parameters (C). At each round t, the scheduling module 216 takes samples from the space of control parameters such that the response parameters are optimized (e.g., reduced cost, higher accuracy, lower completion time, and the like, which are advantageous/beneficial to the requester and should not be construed to mean a mathematically-provable optimum/maximum of the values of the response parameters) for the entire batch. At each round t using the Bayesian Optimization method, the scheduling module 216 uses the knowledge gained in the previous batch of tasks to learn the unknown function ƒ(x). In an embodiment, for example, the knowledge gained corresponds to information of the crowdworkers behavior (in terms of the response parameters) on the selected service platform.

At each round t the scheduling module 216 decides the one or more control parameters xₜ to sample from the domain D. In an embodiment, using a set of rules discussed later, the assumptions made about the unknown function ƒ(x) help in identifying the regret bounds. These regret bounds are further considered while scheduling the next batch of tasks to be executed on the selected service platform. In an embodiment, the values of the one or more control parameters and the values of the one or more response parameters received in the requester's preferences may include an upper limit or a lower limit to ensure that the scheduling is completed as per the requester's requirements.

The Bayesian Optimization method models the unknown function ƒ(x) as a Gaussian Process (GP) by understanding the distribution of the one or more control parameters over the function ƒ. Using the GP, the distribution of the one or more control parameters is specified as (μ(x),k(x,x′)) where μ(x) represents a mean function and k(x,x′) represents its covariance (or kernel) function. The Bayesian Optimization method takes historical data to train a GP and obtain a first GP prior. This GP prior is used to model the one or more control parameters for the next batch of tasks in the next round. A posterior GP of a previous round is the GP prior of the next round, and both the posterior GP and prior GP is a GP distribution.

For a sample, at points y_{T}=[y₁, . . . , y_{T}]^{T} D_{T}={x₁, . . . , x_{T}}, yₜ=ƒ(xₜ) òₜ, i.e., with the independent and identically distributed (i.i.d.) Gaussian noise òₜ˜N(0,σ²), the posterior GP of ƒ has the expressions of mean, covariance, and variance as shown below:

μ_{T}(x)=k_{T}(x)^{T}(K_{T}σ²I)⁻¹y_{T′}+

k_{T}(x,x′)=k(x,x′)−k_{T}(x)^{T}(K_{T}+σ²I)⁻¹k_{T}(x′)

σ_{T}²(x)=k_{T}(x,x)

where,

k_{T}(x)=[k(x₁,x) k(x_{T}, . . . x)]^{T} and K_{T} is the positive definite kernel matrix [k(x,x′)]_{x,x′εD}_{_{T}}.

In an embodiment, the Bayesian Optimization method performs sampling from D at each round t using an ‘upper confidence bound’ rule (UCB rule). Let x be the vector (comprising of values for the control parameters C) that is chosen in each round t of the algorithm. xₜ in each round t is chosen such that:

xₜ=argmax_{xεD}μₜ₋₁(x)+βₜ^{1/2}σₜ₋₁(x),

where

σₜ₋₁ and μₜ₋₁ are the variance and mean functions of the GP at the end of round t−1, and

βₜ is a constant that affects the regret bound. Intuitively, the method samples from the known regions of the GP that have high mean (resulting in function values closer to the maxima) and the unknown regions of high variance, as a result the Bayesian Optimization method may optimize performances of the one or more response parameters and learn from the values of the one or more control parameters and the values of the one or more response parameters used for the previous batch of tasks.

At step 310, the responses are received from the service platform for the current batch of tasks. In an embodiment, the platform connector module 218 receives responses corresponding to the current batch of tasks from the selected service platform and stores the responses in the task statistics data 232.

At step 312, the optimization model is updated. In an embodiment, the maintenance module 220 determines the values of the one or more EOCs from the task statistics data 232 of the selected service platform and updates the optimization model in the scheduling data 228.

The optimization model is updated using the following iterative algorithm:

Input: GP prior, domain D for t=1, 2, 3, . . . , T

Obtain xₜ from the UCB rule

Evaluate response parameters at xₜ (by sending the tasks to the selected service platform with parameters specified by xₜ)

Perform the Bayesian update on GP to obtain σₜ and μₜ (using responses from previous step).

In an embodiment, the number of rounds T could be set experimentally or heuristically based on limits decided for the one or more control parameters and the one or more response parameters. For example, the limits may be set for batch completion time or maximum response time for each round t. Alternatively, the number of rounds T may be determined using previously used values to predict the value for the best performance of the one or more response parameters.

Although T is fixed in advance, it is possible that the batch of tasks is completed before T rounds. In this case, the Bayesian optimization method optimizes the one or more control parameters (e.g., the completion time) and the one or more response parameters. On nearing the limits of the one or more control parameters and the one or more response parameters the scheduling module 216 stops the execution of the Bayesian optimization method and enters a ‘rapid completion mode’ wherein it sends all the remaining tasks to the selected service platform with the existing one or more control parameters, the one or more response parameters, and the limits associated with it. In an embodiment, the limits of the one or more control parameters and the one or more response parameters, and when the scheduling module 216 stops the execution of the Bayesian optimization method may be set as default or learnt from the execution of the current batch of tasks.

Using the Gaussian Process Optimization described in publication by N. Srinivas, et al., titled “Gaussian Process Optimization in the Bandit Setting: No Regret and Experimental Design”, Proceedings of the International Conference on Machine Learning (ICML) 2010, the regret bounds can be computed using the expressions described below: Let D be finite, where βₜ=2 log(|D|t²π²/6δ) and parameter δε(0,1). Here, δ is a parameter whose value can be adjusted by the user. In an embodiment, a better solution (e.g., a suitable recommendation) may be obtained by using lower value of δ. The above algorithm for a sample function ƒ of a GP with mean 0 and covariance function k(x,x′) obtains a regret bound of O*\sqrt{Tγ_{T} log(|D|)} with high probability, where O is the complexity obtained from round T. Also the GP prior is given by, Pr{R_{T}≦\sqrt{C₁Tβ_{T}γ_{T}}∀T≧1}≧1−δ, where C₁=8/log(1δ⁻²). The bound depends on the quantity γₜ which in turn depends on the spectrum of the covariance matrix K, where γₜ represents the maximum information gain. Let the spectrum (the set of Eigen values) be λ₁≧λ₂≧ . . . , the bound γₜ is computed for, any T*=1, . . . , T as:

γ_{T}≦O(σ⁻²[B(T*)+T*(log(n_{T})T)])

where

$${n}_{T} = {\sum }_{t = 1}^{\vert D \vert} {λ}_{t} , B ( {T}^{*} ) = {\sum }_{t = {T}^{*} + 1}^{\vert D \vert} {λ}_{t} ,$$

and B is the Bessel function.

The parameter δ is chosen by the requester wherein a low value (close to 0) increases the probability of achieving the regret bound and is recommended. The regret bound is affected on varying the value of T and the size of the domain D. The domain D is finite and its size depends on the number of possible values set for the control parameters C. The obtained regret bound is used as the theoretical guarantees by the response module 223 and displayed to the requester on the output terminal 204 after the complete execution of the plurality of tasks.

At step 314, the plurality of tasks is checked for completeness. When there are remaining tasks to be executed in the plurality of tasks, the step 308 is performed for allocating the remaining batches of tasks.

At step 316, the statistical model for the service platform is updated. In an embodiment, the maintenance module 220 updates the statistical model maintained for the selected service platform in the model data 226 based on the optimization model generated after the execution of the plurality of tasks. The maintenance module 220 retrieves the scheduling data 228 containing the optimization model generated after the execution of the plurality of tasks and updates the statistical model maintained for the selected service platform using pattern classification methods which may include, but are not limited to, a discriminant function, a probability distribution function, or a generative model function. The pattern classification methods are disclosed in the U.S. patent application entitled, “METHOD AND SYSTEM FOR RECOMMENDING CROWDSOURCING PLATFORMS”, application Ser. No. 13/794,861, filed on Mar. 12, 2013 (Attorney File 20121075), and assigned to the same assignee.

The optimization model described in the flow diagram 300 corresponds to a model whose aim is to find a balance between the expectations stated in the requester's preferences and the values achieved in the responses received from the service platform. In an embodiment, for example, the scheduling allocation of the plurality of tasks using the optimization model provide the optimized values (e.g., reduced cost in the values determined in the responses received) for the execution of the plurality of tasks by submitting the plurality of tasks in batches (e.g., based on the batch size as stated in the requester's preferences) on to the service platform at the predefined intervals. Furthermore, the optimized values generated using the optimization model shall be construed broadly to mean any advantageous result such as reduced cost, higher accuracy, lower completion time, and the like, in a given practical situation, and should not be construed to mean a mathematically-provable optimum/maximum.

The disclosed methods and systems, as illustrated in the ongoing description or any of its components, may be embodied in the form of a computer system. Typical examples of a computer system include a general-purpose computer, a programmed microprocessor, a microcontroller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard disk drive or a removable storage drive, such as, a floppy disk drive, optical disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through an input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The method and systems described can also be implemented using only software programming or hardware or by a varying combination of the two techniques. The disclosure is independent of the programming language and the operating system used in computers. The instructions for the disclosure can be written in all programming languages including, but not limited to, ‘C’, ‘C++’, ‘Visual C++’, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product, as described above, have numerous advantages. The method allows for performing the optimal scheduling of tasks in dynamically changing service platforms. The method allows fine-grained control and can adapt to rapidly changing characteristics of the service platform which leads to superior optimization with respect to the task execution schedule. The method makes no assumptions about the characteristics of the underlying service platform and offers the stochastic solution for scheduling the tasks to obtain the best performance. Furthermore, it improves the scheduling of tasks in an environment where the service platform provider is an enterprise partner of the requester.

Various embodiments of the methods and systems for scheduling allocation of plurality of tasks on the service platform have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above-disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed:

1. A computer-implemented method for scheduling allocation of a plurality of tasks to a service platform, the computer-implemented method comprising:
allocating a current batch of tasks from the plurality of tasks to the service platform based on an optimization model, wherein the optimization model alters values of one or more control parameters for the current batch of tasks based on values of one or more response parameters derived from responses received for a previous batch of tasks, and wherein the optimization model is built by machine learning on the responses received from the service platform; and
updating the optimization model after at least one of an expiry of a predefined time interval or receiving the responses for the current batch of tasks.

2. The computer-implemented method according to claim 1 further comprising receiving user preferences for the values of the one or more control parameters and the one or more response parameters of the plurality of tasks from a requester for allocation.

3. The computer-implemented method according to claim 2, wherein the values of the one or more control parameters and the values of the one or more response parameters received in the user preferences comprises at least one of an upper limit or a lower limit.

4. The computer-implemented method according to claim 1, wherein the service platform is selected from a plurality of service platforms based on a first request from a requester.

5. The computer-implemented method according to claim 1, wherein the plurality of tasks is uploaded to the service platform based on a second request from a requester.

6. The computer-implemented method according to claim 1, wherein the one or more response parameters correspond to one or more externally observable characteristics of the service platform depending on the responses received from the service platform.

7. The computer-implemented method according to claim 6, wherein the one or more externally observable characteristics correspond to task performance measures, task characteristics, and/or spatio-temporal measures,
wherein the task performance measures comprises at least one of accuracy, response time, or completion time,
wherein the task characteristics comprises at least one of cost, number of judgments, or task category, and
wherein the spatio-temporal measures comprises at least one of time of submission, day of week, or worker origin.

8. The computer-implemented method according to claim 1, wherein the predefined time interval corresponds to a completion time of the current batch of tasks.

9. The computer-implemented method according to claim 1, wherein the optimization model is generated based on a Bayesian Optimization solution on the one or more control parameters of the plurality of tasks.

10. A computer-implemented method for scheduling allocation of a plurality of tasks to a crowdsourcing platform, the computer-implemented method comprising:
receiving user preferences for values corresponding to one or more control parameters and one or more response parameters of the plurality of tasks;
allocating a current batch of tasks from the plurality of tasks to the crowdsourcing platform based on an optimization model, wherein the optimization model alters values of one or more control parameters for the current batch of tasks based on values of one or more response parameters derived from responses received for a previous batch of tasks, and wherein the optimization model is built by machine learning on the responses received from the crowdsourcing platform; and
updating the optimization model after at least one of an expiry of a predefined time interval or receiving the responses for the current batch of tasks.

11. A system for managing allocation of a plurality of tasks to a crowdsourcing platform, the system comprising:
a scheduling module configured for:
allocating a current batch of tasks from the plurality of tasks to the crowdsourcing platform based on an optimization model, wherein the optimization model alters values of one or more control parameters for the current batch of tasks based on values of one or more response parameters derived from responses received for a previous batch of tasks, and wherein the optimization model is built by machine learning on the responses received from the crowdsourcing platform; and
a maintenance module configured for updating the optimization model after at least one of an expiry of a predefined time interval or receiving the responses for the current batch of tasks.

12. The system according to claim 11 further comprising a specification module configured for receiving user preferences for the values corresponding to one or more control parameters and one or more response parameters of the plurality of tasks.

13. The system according to claim 11 further comprising an upload module configured for:
receiving a first request for selecting the service platform from a plurality of service platforms for the plurality of tasks; and
uploading the plurality of tasks to the service platform based on a second request.

14. The system according to claim 11 further comprising a platform connector module configured for receiving responses corresponding to the plurality of tasks from the service platform.

15. The system according to claim 11 further comprising a task statistics module configured for storing performance statistics of the one or more control parameters and the one or more response parameters for the plurality of tasks.

16. A computer program product for use with a computer, the computer program product comprising a computer-usable medium storing a computer-readable program code for managing allocation of a plurality of tasks to a service platform, the computer-readable program comprising:
program instruction means for allocating a current batch of tasks from the plurality of tasks to the service platform based on an optimization model, wherein the optimization model alters values of one or more control parameters for the current batch of tasks based on values of one or more response parameters derived from responses received for a previous batch of tasks, and wherein the optimization model is built by machine learning on the responses received from the service platform; and
program instruction means for updating the optimization model after at least one of an expiry of a predefined time interval or receiving the responses for the current batch of tasks.

17. The computer-readable program according to claim 16 further comprising program instruction means for receiving user preferences for the values of the one or more control parameters and the one or more response parameters of the plurality of tasks from a requester for allocation.

18. The computer-readable program according to claim 16 further comprising program instruction means for uploading the plurality of tasks to the service platform based on a second request from a requester.

19. The computer-readable program according to claim 16, wherein the optimization model is generated based on a Bayesian Optimization solution on the one or more control parameters of the plurality of tasks.
